(19) United States
(12) Patent Application Publication
(10) Pub. No.: US 2009/0226078 A1
(43) Pub. Date: Sep. 10, 2009

(54) Method and apparatus for aligning a substrate and for inspecting a pattern on a substrate

(76) Inventors: Yong-Ju Kim, Suwon-si (KR); Kwang-Sik Kim, Yongin-si (KR)

Correspondence Address: HARNESS, DICKEY & PIERCE, P.L.C., P.O. BOX 8910, RESTON, VA, 20195, US

(21) Appl. No.: 12/385,192

(22) Filed: Apr. 1, 2009

Related U.S. Application Data
(63) Continuation of application No. 11/175,436, filed on Jul. 7, 2005.

(30) Foreign Application Priority Data
Jul. 26, 2004 (KR) 2004-58145

(51) Int. Cl. G06K 9/00; G01B 11/00

(52) U.S. Cl. 382/151; 356/401

(57) ABSTRACT

In a method and apparatus of aligning a substrate, a mark image may be generated from an alignment mark on the substrate. The mark image may be generated after a given process for manufacturing a semiconductor device including the substrate has been performed. The mark image may be compared with a given reference image, and the substrate may be aligned based on the comparison, so that the alignment mark corresponds to one of the reference image and the mark image. The alignment method may be used in a method of inspecting the substrate, wherein the process after which the mark image is created is performed in accordance with a process recipe to form a pattern. The inspection method may include inspecting whether the pattern from the aligned substrate corresponds to the process recipe.

### CLAIM TO PRIORITY

This application claims priority under 35 USC § 119 to Korean Patent Application No. 2004-58145, filed on Jul. 26, 2004, the entire contents of which are hereby incorporated by reference.

### BACKGROUND OF THE INVENTION

1. Field of the Invention

The present invention relates, in general, to a method and an apparatus for aligning a substrate and for inspecting a pattern on a substrate.

2. Description of the Related Art

Generally, a semiconductor device may typically be manufactured using hundreds of processes. Various patterns are formed on a semiconductor substrate by each of the processes. The patterns may have characteristics corresponding to given process recipes. Additionally, a process for inspecting whether a thickness and a critical dimension (CD) of the pattern correspond to a designed thickness and a designed CD may typically be performed between the processes.

In a conventional method of inspecting a pattern, a reference pattern is stored in a storing-unit, and a pattern on a semiconductor substrate is measured. The measured pattern is compared with the reference pattern to determine whether the pattern is abnormal.

To inspect a pattern on a semiconductor substrate, the semiconductor substrate is accurately aligned on a stage of an inspection tool. In a conventional method of aligning a semiconductor substrate, a first process is carried out on the semiconductor substrate in accordance with a first process recipe to form a first pattern on the semiconductor substrate. A first reference image is obtained from an alignment mark that is formed on a scribe lane of the semiconductor substrate. Here, the first reference image may typically be obtained from light that is reflected from the alignment mark. The first reference image is set up in an inspection tool. The semiconductor substrate is aligned to the alignment mark with the first reference image. An inspection may be made to determine whether the first pattern corresponds to the first process recipe.

A second process is carried out on the semiconductor substrate in accordance with a second process recipe to form a second pattern on the semiconductor substrate. A second reference image is obtained from the alignment mark that is formed on the scribe lane of the substrate and covered by the second pattern. After the first reference image is deleted from the inspection tool, the second reference image is set up in the inspection tool. The semiconductor substrate is aligned to the alignment mark with the second reference image, and an inspection may be made to determine whether the second pattern corresponds to the second process recipe.

The above-mentioned process for aligning the semiconductor substrate is performed on a plurality of patterns to be formed on the semiconductor substrate in accordance with the aforementioned first and second process recipes. The patterns are then inspected.

According to the conventional method, since the patterns are continuously formed on the alignment mark, the light reflected from the alignment mark in each of the first and second process recipe processes have different characteristics. Thus, each of the reference images is set up in the inspection tool in accordance with its particular process.

However, a first pattern formed in a preceding (or first) process may have characteristics such as a property, a thickness, etc., substantially identical to those of a second pattern formed in a following (or next) process. Therefore, a first light reflected from the alignment mark in the preceding process may have characteristics substantially identical to that of a second light reflected from the alignment mark in the following process.

In spite of the above-mentioned condition (e.g., where light characteristics are the same), in the conventional method, the semiconductor substrate is aligned using different reference images. This prolongs the time needed for inspecting the semiconductor substrate. In particular, since a semiconductor device is manufactured by hundreds of processes, this time loss caused by the above-mentioned conventional method may be a substantial problem in manufacturing the semiconductor device.

### SUMMARY OF THE INVENTION

An example embodiment of the present invention is directed to a method of aligning a substrate. In the method, a mark image may be generated from an alignment mark on the substrate. The mark image may be generated after a given process for manufacturing a semiconductor device including the substrate has been performed. The mark image may be compared with a given reference image, and the substrate may be aligned based on the comparison, so that the alignment mark corresponds to one of the reference image and the mark image.

Another example embodiment of the present invention is directed to a method of inspecting a pattern on a substrate, in which a substrate may be aligned as described in the previous example embodiment, and where the process after which the mark image is created may be performed in accordance with a process recipe to form a pattern. The method may further include inspecting whether the pattern corresponds to the process recipe.

Another example embodiment is directed to an apparatus for aligning a substrate. The apparatus may include an image-creating unit creating a mark image of an alignment mark on the substrate after a given process for manufacturing a semiconductor device including the substrate has been performed, and an image storing unit for storing the mark image and a given reference image. The apparatus may include an image-processing unit comparing the mark image with the reference image to generate a signal, and a substrate-aligning unit aligning the substrate based on the signal from the image-process unit.

Another example embodiment is directed to an apparatus for inspecting a pattern on a substrate. The apparatus may include the apparatus for aligning a substrate as described in the above example embodiment, wherein the given process after which the mark image is created is performed in accordance with a process recipe to form a pattern. The apparatus may further include a pattern-inspecting unit for inspecting whether the pattern has characteristics corresponding to the process recipe.

Another example embodiment is directed to a method of aligning a substrate, which may include comparing a mark image that is generated from an alignment mark on a substrate to a given reference image, and aligning the substrate based on the comparison. The mark image may be generated after a given processing step for forming a semiconductor device including the substrate, and the reference image may be determined prior to performing the given processing step.

Another example embodiment is directed to a method of inspecting a pattern on a substrate, which may include forming a pattern on a substrate as part of a process recipe for manufacturing a semiconductor device, and aligning the substrate as defined in the above example embodiment. The method may include inspecting whether the pattern corresponds to the process recipe.

Another example embodiment is directed to an apparatus for aligning a substrate. The apparatus may include at least an image-creating unit creating a mark image of an alignment mark on the substrate after a given processing step for forming a semiconductor device including the substrate has been performed, and an image-processing unit comparing the mark image with a stored reference image to generate a signal. The apparatus may include a substrate-aligning unit aligning the substrate based on the generated signal from the image-processing unit.

Another example embodiment is directed to an apparatus for inspecting a pattern on a substrate, which may include the apparatus for aligning a substrate as described in the above example embodiment immediately above, wherein the given processing step after which the mark image is created is performed in accordance with a process recipe to form a pattern. The apparatus may further include a pattern-inspecting unit for inspecting whether the pattern has characteristics corresponding to the process recipe.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limitative of the example embodiments the present invention.

FIG. 1 is a block diagram illustrating an apparatus for aligning a substrate in accordance with an example embodiment of the present invention.

FIG. 2 is a flow chart illustrating a method of aligning a substrate using the example apparatus in FIG. 1.

FIG. 3 is a block diagram illustrating an apparatus for inspecting a pattern on a substrate in accordance with another example embodiment of the present invention.

FIG. 4 is a flow chart illustrating a method of inspecting a pattern on a substrate using the apparatus in FIG. 3.

### DETAILED DESCRIPTION OF THE EXAMPLE EMBODIMENTS

The present invention is described more fully hereinafter with reference to the accompanying drawings, in which example embodiments of the invention are shown. This invention may, however, be embodied in many different forms and should not be construed as limited to the example embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the example embodiments of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Example Embodiment 1

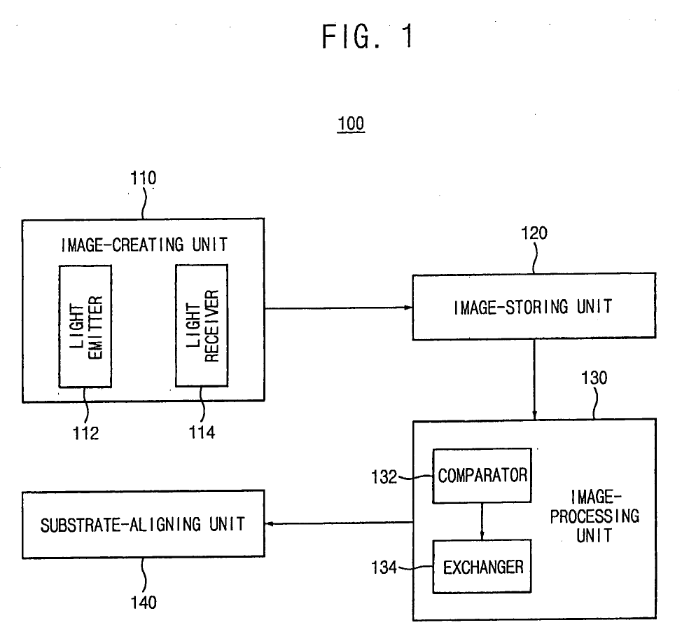

FIG. 1 is a block diagram illustrating an apparatus for aligning a substrate in accordance with an example embodiment of the present invention. Referring to FIG. 1, an apparatus 100 for aligning a substrate may include an image-creating unit 110. The image-creating unit 110 may be configured to create a mark image of an alignment mark that is formed on a scribe lane of a semiconductor substrate on which a process for manufacturing a semiconductor device has been performed. Apparatus 100 may include an image-storing unit 120 for storing the mark image and a reference image therein, an image-processing unit 130 for processing the mark image and the reference image, and a substrate-aligning unit 140 for aligning the semiconductor substrate in accordance with a signal from the image-processing unit 120.

The image-creating unit 110 may include a light emitter 112 for irradiating a light onto the alignment mark, and a light receiver 114 for receiving light reflected from the alignment mark. The reflected light in the light receiver 114 may include information with respect to the alignment mark, such that the mark image may be obtained from the reflected light.

The mark image created from the image-creating unit 110 is stored in the image-storing unit 120. Also, the reference image is stored in the image-storing unit 120. Here, the mark image may correspond to the alignment mark after performing a given manufacturing process and the reference image corresponds to the alignment mark before performing the given manufacturing process. In an example, the given manufacturing process may be any pattern-forming process used to form the semiconductor substrate.

The image-processing unit 130 may include a comparator 132 and an exchanger 134. The comparator 132 compares the mark image with the reference image. A signal corresponding to the comparison results may be input to the exchanger 134. The exchanger 134 exchanges the reference image for the mark image, or keeps the reference image in the image-storing unit 120, based on the comparison results.

In an example, when the mark image is within an allowed range set up for the reference image, the semiconductor substrate is aligned so that the alignment mark may correspond to the reference image (e.g., without using a new reference image). Thus, the exchanger 134 does not exchange the reference image for the mark image. But if the mark image is outside the allowed range, the semiconductor substrate is aligned but the alignment mark does not correspond to the reference image. Thus, the exchanger 134 exchanges the reference image for the mark image. The exchanger 134 then stores the mark image as a new reference image in the image-storing unit 120.

The substrate-aligning unit 140, in general, aligns the semiconductor substrate in accordance with the current reference image or the new reference image. In an example, the semiconductor substrate may be positioned on a stage of an alignment tool. The substrate-aligning unit 140 moves the stage so that the alignment mark may correspond to the current reference image or the new (e.g., revised or modified) reference image, thereby aligning the semiconductor substrate.

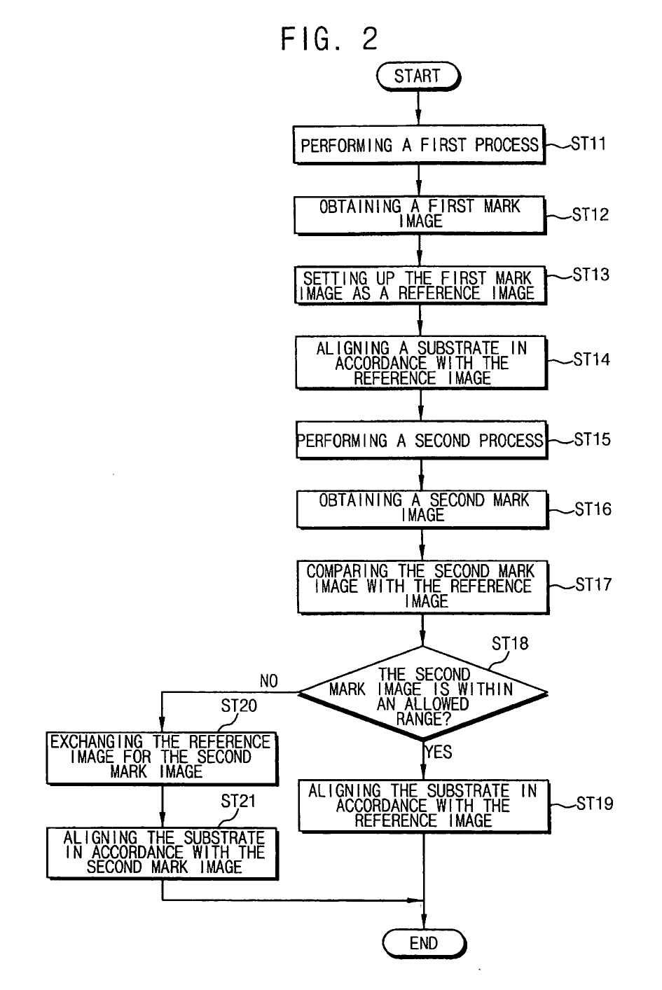

FIG. 2 is a flow chart illustrating a method of aligning a substrate using the apparatus in FIG. 1. Referring to FIGS. 1 and 2, a first process may be performed on a semiconductor substrate (ST11) in accordance with a first process recipe to form a first pattern on the semiconductor substrate. Here, the first pattern may partially cover an alignment mark on a scribe lane of the semiconductor substrate. The image-creating unit 110 may create a first mark image of the alignment mark (ST12). In an example, the light emitter 112 irradiates a light onto the alignment mark. A light reflected from the alignment mark may be collected in the light receiver 114 to obtain the first mark image. The first mark image may then be stored (ST13) in the image-storing unit 120 as a reference image. The substrate-aligning unit 140 may align (ST14) the semiconductor substrate so that the alignment mark may correspond to the reference image.

A second process may be carried out on the semiconductor substrate in accordance with a second process recipe (ST15) to form a second pattern on the semiconductor substrate. Here, the second pattern may be partially positioned over the alignment mark.

The image-creating unit 110 may create a second mark image of the alignment mark (ST16) after performing the second process (e.g., pattern forming process corresponding to the second process recipe). Here, a light reflected from the alignment mark covered by the first and second patterns may have different characteristics than the light reflected from the alignment mark covered by the first pattern. Thus, in this example, the second mark image has light characteristics different from those of the first mark image.

The comparator 132 compares the second mark image with the reference image (ST17) by overlapping the second mark image with the reference image. The comparator 132 determines (ST18) whether (or not) the second mark image is within an allowed range set up for the reference image. Here, the second mark image corresponds to the alignment mark after performing the second process (e.g., corresponding to the second process recipe), and the reference image corresponds to the alignment mark after having performed the first process. The second mark image is slightly different from the reference image. However, if the second mark image is within the allowed range, the semiconductor substrate is aligned using the current or original reference image. Therefore, the exchanger 134 does not need to exchange the current reference image that corresponds to the second mark image. The substrate-aligning unit 140 may then align (ST19) the semiconductor substrate so that the alignment mark (the mark corresponding to the completion of the second process) corresponds to the reference image.

On the other hand, if the second mark image is outside the allowed range, the semiconductor substrate is not aligned using the current reference image. Thus, the exchanger 134 exchanges (ST20) the reference image for the second mark image. The second mark image is stored in the image-storing unit 120 as a new reference image. The substrate-aligning unit 140 then aligns the semiconductor substrate so that the alignment mark corresponding to the second process thus corresponds to the second mark image.

According to this example embodiment, the semiconductor substrate is aligned without exchanging the reference image for new reference images in each of the processes. Thus, time for aligning the semiconductor substrate may be substantially remarkably reduced.

### Example Embodiment 2

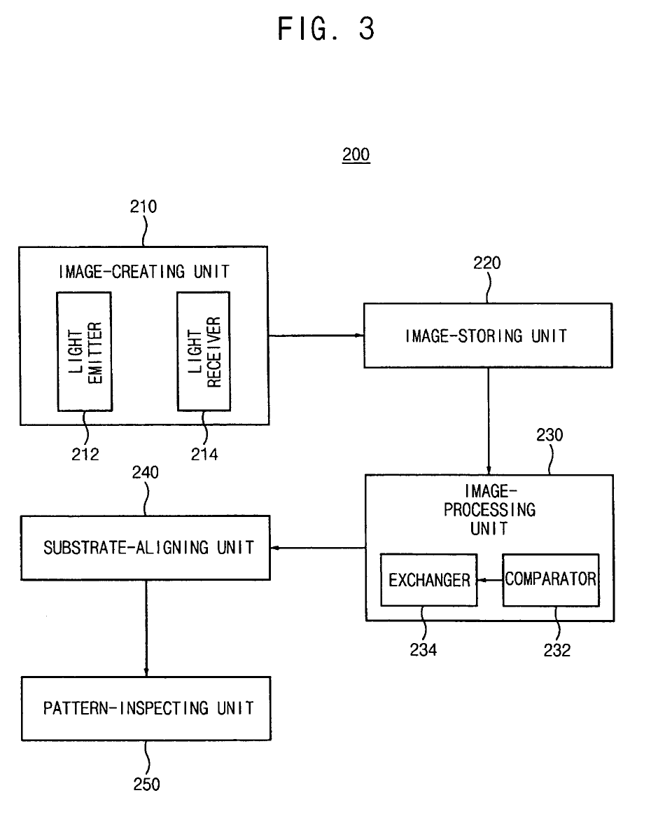

FIG. 3 is a block diagram illustrating an apparatus for inspecting a pattern on a substrate in accordance with another example embodiment of the present invention. Referring to FIG. 3, an apparatus 200 for inspecting a pattern on a substrate in may include an image-creating unit 210 for creating a mark image of an alignment mark, an image-storing unit 220 for storing the mark image and a reference image therein, an image-processing unit 230 for processing the mark image and the reference image, a substrate-aligning unit 240 for aligning the semiconductor substrate in accordance with a signal from the image-processing unit 230, and a pattern-inspecting unit 250 for inspecting a pattern on the aligned semiconductor substrate.

The image-creating unit 210 may include a light emitter 212 for irradiating a light onto the alignment mark, and a light receiver 214 for receiving a light reflected from the alignment mark. The image-processing unit 230 may include a comparator 232 and an exchanger 234. The comparator 232 may compare the mark image with the reference image. The exchanger 234 may exchange the reference image for the mark image, or keep the existing or current reference image in the image-storing unit 220, based on the comparison results.

The substrate-aligning unit 240 may align the semiconductor substrate so that the alignment mark (e.g., the alignment mark that is formed on a scribe lane of the semiconductor substrate after a given patterning process such as a first process recipe) corresponds to the current reference image, or to a new reference image corresponding to the mark image. The pattern-inspecting unit 250 inspects the pattern on the semiconductor substrate aligned by the substrate-aligning unit 240. The pattern-inspecting unit 250 may measure one or more of a thickness, a concentration, a critical dimension (CD), etc., of the pattern. The pattern-inspecting unit 250 may determine whether one or more of the thickness concentrations and/or the CD of the pattern correspond to a designed thickness, a designed concentration and/or a designed CD of the pattern. For example, to measure the concentration and the thickness of the pattern, the pattern-inspecting unit 250 irradiates a light onto the pattern. The light may be partially absorbed in the pattern. A non-absorbed light in the pattern may be Fourier transformed to obtain an absorption spectrum of the light absorbed in the pattern. A height and an area of a light absorption peak may be measured from the absorption spectrum. A height ratio of the light absorption peak is analyzed to obtain the concentration of the pattern. The height and the area of the light absorption peak are compared with a predetermined data to obtain the thickness of the pattern.

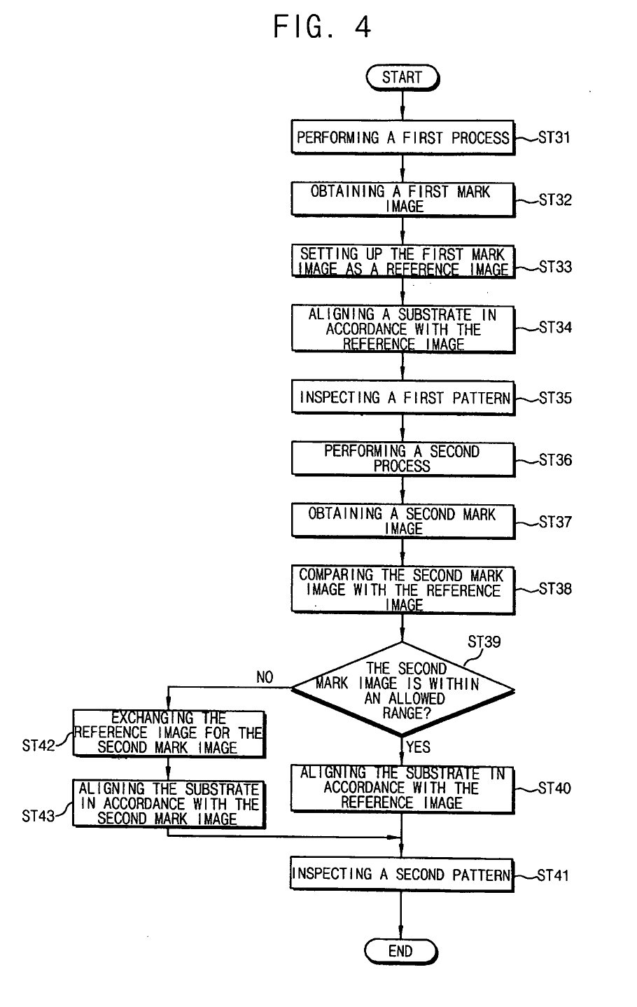

FIG. 4 is a flow chart illustrating a method of inspecting a pattern on a substrate using the apparatus in FIG. 3. Referring to FIGS. 3 and 4, a first process may be performed (ST31) on a semiconductor substrate in accordance with a first process recipe, for example, to form a first pattern on the semiconductor substrate. The image-creating unit 210 may create a first mark image of the alignment mark (ST32) formed on a scribe lane of the semiconductor substrate. For example, the light emitter 212 may irradiate a light onto the alignment mark. A light reflected from the alignment mark is collected in the light receiver 214 to obtain the first mark image. The first mark image may be stored (ST33) in the image-storing unit 220 as a reference image. The substrate-aligning unit 240 may align the semiconductor substrate (ST34) so that the alignment mark corresponds to the reference image, and the pattern-inspecting unit 250 may measure (ST35) one or more of a thickness and a CD of the first pattern. The pattern-inspecting unit 250 is configured to recognize whether the measured thickness and/or CD corresponds to a thickness and/or a CD designed in accordance with the first process recipe (or not) to determine if the first pattern is normal or abnormal.

As shown in FIG. 4, a second process may be carried out on the semiconductor substrate (ST36) in accordance with a second process recipe to form a second pattern on the semiconductor substrate. The image-creating unit 210 may create a second mark image of the alignment mark after (ST37) a second process has been carried out on the substrate. The comparator 232 then may compare the second mark image with the reference image (ST38) by overlapping the second mark image with the reference image, and may determine whether the second mark image is within an allowed range set up for the reference image (ST39).

If the second mark image is within the allowed range, the substrate-aligning unit 240 aligns the semiconductor substrate (ST40) so that the alignment mark after performing the second process may correspond to the reference image. The pattern-inspecting unit 250 then may measure one or more of a thickness and a CD of the second pattern (ST41). The pattern-inspecting unit 250 is configured to recognize whether the measured thickness and/or CD corresponds to a thickness and/or a CD designed in accordance with the first process recipe, to determine if the second pattern is normal or abnormal.

On the contrary, if the second mark image is outside the allowed range, the exchanger 234 exchanges the reference image for the second mark image (ST42). The second mark image is stored in the image-storing unit 220 as a new reference image.

The substrate-aligning unit 240 then aligns (ST43) the semiconductor substrate so that the alignment mark after performing the second process may correspond to the second mark image. The pattern-inspecting unit 250 then may inspect whether the second pattern has characteristics corresponding to the second process recipe (or not), to determine if the second pattern is normal or abnormal.

According to an example embodiment, the semiconductor substrate may be aligned without exchanging the reference image for new reference images in each of the processes. Thus, a time needed for aligning the semiconductor substrate may be substantially reduced.

According to example embodiments of the invention, after the image of the alignment mark is compared with the reference image, the reference image is selectively used for aligning the semiconductor substrate in accordance with the comparison results. Thus, the semiconductor substrate may be aligned without new reference images in each of the processes. As a result, required times for aligning the semiconductor substrate and/or for inspecting the pattern may be substantially reduced.

Having described the example embodiments of the present invention, it is noted that modifications and variations can be made by persons skilled in the art in light of the above teachings. It is therefore to be understood that changes may be made in the particular example embodiment of the present invention disclosed which is within the scope and the spirit of the invention, as outlined by the appended claims.

1-31. (canceled)

32. A method of aligning a substrate, comprising:
generating a first mark image from an alignment mark on the substrate after a first process to form a first pattern on the substrate, the first pattern partially covering the alignment mark and being set up as a reference image;
generating a second mark image from the alignment mark after a second process to form a second pattern over the alignment mark;
comparing the second mark image with the reference image of the first mark image; and
aligning the substrate based on the comparison, so that the alignment mark corresponds to one of the reference image and the second mark image.

33. The method of claim 32, wherein the reference image is determined in advance of the first process based on the alignment mark.

34. The method of claim 32, wherein generating includes:
irradiating a light onto the alignment mark after the first process;
collecting light reflected from the alignment mark; and
obtaining the first mark image from the collected light.

35. The method of claim 32, wherein comparing the second mark image further includes overlapping the second mark image with the reference image.

36. The method of claim 32, wherein aligning further includes:
deleting the reference image; and
setting up the second mark image as a new reference image, if the second mark image is outside a specified range for the reference image.

37. A method of inspecting a pattern on a substrate, comprising:
aligning the substrate as defined in claim 32, wherein the first process after which the first mark image is created is performed in accordance with a process recipe to form the first pattern; and
inspecting whether the first pattern corresponds to the process recipe.

38. The method of claim 37, wherein generating includes:
irradiating a light onto the alignment mark after the first process;
collecting light reflected from the alignment mark; and
obtaining the first mark image from the collected light.

39. The method of claim 37, wherein comparing the second mark image further includes overlapping the second mark image with the reference image.

40. The method of claim 37, wherein aligning further includes:
deleting the reference image; and
setting up the second mark image as a new reference image, if the second mark image is outside a specified range for the reference image.

41. An apparatus for aligning a substrate, comprising:
an image-creating unit for creating a first mark image of an alignment mark on the substrate after a first process to form a first pattern on the substrate, the first pattern partially covering the alignment mark and being set up as a reference image, and further creating a second mark image from the alignment mark after performing a second process to form a second pattern over the alignment mark;
an image-storing unit for storing the first mark image and the reference image of the first mark image;
an image-processing unit for comparing the second mark image with the reference image to generate a signal; and
a substrate-aligning unit for aligning the substrate based on the signal from the image-process unit.

42. The apparatus of claim 41, wherein the reference image is determined from the alignment mark prior to the performance of the first process.

43. The apparatus of claim 41, wherein the image-processing unit is configured to selectively exchange the reference image for the second mark image based on results of the comparison.

44. The apparatus of claim 41, wherein the substrate-aligning unit aligns the substrate so that the alignment mark corresponds to one of the reference image and the second mark image.

45. The apparatus of claim 41, wherein the image-creating unit includes:
a light emitter for irradiating a light onto the alignment mark; and
a light receiver for receiving a light reflected from the alignment mark to generate the first mark image.

46. The apparatus of claim 41, wherein the image-processing unit includes:
a comparator for comparing the second mark image with the reference image; and
an exchanger for selectively exchanging the reference image for the second mark image, based on the comparison.

47. An apparatus for inspecting a pattern on a substrate, comprising:
the apparatus for aligning a substrate as defined in claim 41, wherein the first process after which the first mark image is created is performed in accordance with a process recipe to form the first pattern; and
a pattern-inspecting unit for inspecting whether the first pattern has characteristics corresponding to the process recipe.

48. The apparatus of claim 47, wherein the image-creating unit includes:
a light emitter for irradiating a light onto the alignment mark; and
a light receiver for receiving a light reflected from the alignment mark to generate the first mark image.

49. The apparatus of claim 47, wherein the image-processing unit includes:
a comparator for comparing the second mark image with the reference image; and
an exchanger for selectively exchanging the reference image for the second mark image based on results of the comparison.
